(19) United States
(12) Patent Application Publication
(10) Pub. No.: US 2011/0029436 A1
(43) Pub. Date: Feb. 3, 2011

(54) Methods And Systems For Delivering Sponsored Out-Of-Band Passwords

(75) Inventors: Joel Norvell, Portland, OR (US); James L. Sontag, Portland, OR (US)

Correspondence Address: TOMLINSON & O'CONNELL, P.C., TWO LEADERSHIP SQUARE, 211 NORTH ROBINSON, SUITE 450, OKLAHOMA CITY, OK, 73102, US

(73) Assignee: Vidoop, LLC, Portland, OR (US)

(21) Appl. No.: 12/525,963

(22) PCT Filed: Feb. 5, 2008
(86) PCT No.: PCT/US08/53090

§ 371 Date: Oct. 18, 2010

Related U.S. Application Data
(60) Provisional application No. 60/888,312, filed on Feb. 5, 2007.

(51) Int. Cl. H04K 1/00

(52) U.S. Cl. 705/67

(57) ABSTRACT

Methods and systems for delivering advertising content to selected users in combination with out-of-band passwords or access code information delivered over a selected communication medium.

This application claims the benefit of priority to U.S. provisional patent application Ser. No. 60/888,312 filed on Feb. 5, 2007, which is incorporated by reference herein in its entirety.

### FIELD OF THE INVENTION

The invention relates to targeted advertising and distribution of authentication information. More particularly, the invention relates to methods and apparatus for delivering sponsored messages or advertisements accompanying out-of-band passwords or access codes.

### BACKGROUND

Together with the growth of online resources for accessing a variety of services and performing a variety of transactions, identity theft has reached epidemic levels. Online account takeover and transaction fraud is growing at an enormous rate. These individuals committing such acts of fraud (aka “fraudsters”) currently have and will continue to develop new technologies at their disposal for perpetrating criminal acts online. For example, key loggers may be installed in unsuspecting customer computers that can transmit personal information back to a fraudster. Phishing attacks may also trick consumers into divulging personal and financial information such as for example without limitation a social security number (“SSN”), account numbers, banking information, personal identification numbers (“PINs”), credit card numbers, user names and passwords for various services.

A primary issue for deterring fraud online is user authentication—how does a service or transaction provider know whether a certain user accessing a service and performing actions at a certain site is who he or she claims to be. Many solutions have been proposed for the problem of authentication, however many of them encounter an imbalance between usability vs. security. For example, such solutions may not be secure enough, or, when security is enhanced to satisfactory levels, they are cumbersome and expensive to deploy and operate. Various service providers use different types of information in order to authenticate users in remote applications. Authentication may be required whenever a sensitive operation or task is being performed or takes place such as viewing personal information, initiating financial transactions and updating a user or customer profile. The use of a login or user identification (ID) number and password is one of the most prevalent methods of authentication.

During an authentication procedure, a user may be prompted to supply a password. The password may be a temporary (e.g., one-time) or a persistent password. When the password is not previously known or forgotten by the user, it may be sent to the user. For example, this may be accomplished over the same communication channel such as the Internet on which the user is conducting a transaction online. Alternatively, the password may be delivered to the user through a different out-of-band medium such as a home or mobile telephone number that may be pre-registered or otherwise known to a service provider, financial institution or other party requesting authentication. The password typically arrives with minimal user and password information sufficient only to complete the authentication process.

What is needed is an effective way to exploit and utilize the attention of the user during an out-of-band password delivery process.

### SUMMARY OF THE INVENTION

The invention provides methods and systems for providing sponsored out-of-band passwords and access codes. Various aspects of the invention described herein may be applied to any of the particular applications set forth below. The invention may be applied as a standalone advertisement system or as a revenue generating component of an integrated software solution against online fraud and identify theft. The invention can be optionally integrated into existing business and authentication processes seamlessly. It shall be understood that different aspects of the invention can be appreciated individually, collectively or in combination with each other.

A preferable embodiment of the invention provides a method and/or system for delivering targeted advertising and authenticating a user engaged in an online transaction. For example, the user may be requesting a one-time or persistent password for initiating a financial transaction or opening an online account. The user may be communicating with a financial institution on a web site via a first communication channel such as for example the Internet. The targeted advertising system may deliver or transmit to a user selected password information including an alpha- and/or numeric-password or access code, to the user via a second communication channel, (the identification of which may be provided by the user, or may be generated in another manner), for example, a telephone connection, e-mail connection, etc. Such password information may further include a sponsored message or a selected advertisement. In a preferable embodiment of the invention, the advertisement may be targeted based upon information derived about the user based upon known information related to the transaction being conducted. The advertising and authentication system may receive the request from the user via a first communication channel, and subsequently deliver the password information plus selected advertisement to the user via the second communication channel.

In some embodiments of the invention, the first communication channel may be a network such as the Internet while the second communication channel may be a telephone connection. The second communication channel in some instances may be the same communication channel by which the transaction is conducted or a different out-of-band communication channel. For certain embodiments of the invention herein, the phrase “out-of-band authentication” may be described as authentication of a user by sending a one-time password to a device over a communication channel selected beforehand or real-time by the user. Such devices include but are not limited to a cell phone, home phone (landline), mobile device, or e-mail account. This method of delivery for passwords or access codes has been effectively used in many instances to address concerns related to online fraud tactics including those referred to as “man in the middle” attacks.

Unless specifically stated otherwise, as apparent from the following discussions, it is appreciated that throughout the specification, discussions utilizing terms such as “processing,” “computing,” “calculating,” “determining,” or the like, may refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. It will also be appreciated by persons skilled in the art that the term “users” referred to herein can be individuals as well as corporations and other legal entities. Furthermore, the processes presented herein are not inherently related to any particular computer, processing device, article or other apparatus. An example of a structure for a variety of these systems will appear from the description below. In addition, embodiments of the present invention are not described with reference to any particular processor, programming language, machine code, etc. It will be appreciated that a variety of programming languages, machine codes, etc. may be used to implement the teachings of the invention as described herein. Moreover, the invention may be used for online service providers that provide services dependent upon confidential information susceptible to theft or criminal activity. It will be appreciated, however that the invention is not limited to usage by service providers, but rather may also be used by the government, and any other authority or entity that offers access to information of confidential or private nature.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

Some of the features of the invention are described as set forth in the following figures and description. A better understanding of the features and advantages of the invention will be obtained by reference to the following detailed description that sets forth illustrative embodiments provided in accordance with the invention.

FIG. 1 describes an authentication and advertising system that delivers sponsored out-of-band access codes.

FIG. 2 is a flow chart describing a method of delivering sponsored out-of-band access codes.

### DETAILED DESCRIPTION OF THE INVENTION

In the following detailed description, numerous specific details are set forth in order to provide a thorough understanding of the invention. However it will be understood by those of ordinary skill in the art that the invention may be practiced without these specific details. In other instances, well-known methods, procedures, components and circuits have not been described in detail so as not to obscure the invention. Various modifications to the described embodiments will be apparent to those with skill in the art, and the general principles defined herein may be applied to other embodiments. The invention is not intended to be limited to the particular embodiments shown and described.

An aspect of the invention provides delivery of sponsored out-of-band access codes during the course of an online transaction. During the online transaction, an authentication process may be called upon to deliver an out-of-band password to an end user. As part of the authentication process, the end user may request or receive a one-time or persistent password from the authenticating process or service. The password may be delivered to the user over an alternate communication channel that is different than the primary communication channel facilitating the online transaction. A wide variety of alternate communication channels may be used in accordance with the invention such as placing a voice telephone call to a home phone number, a voice call or SMS text message to a cell phone, or an e-mail to an e-mail account which has been previously selected by the user. One or more selected messages from paid sponsors or advertisers may be delivered to the user along with the password over the alternate communication channel.

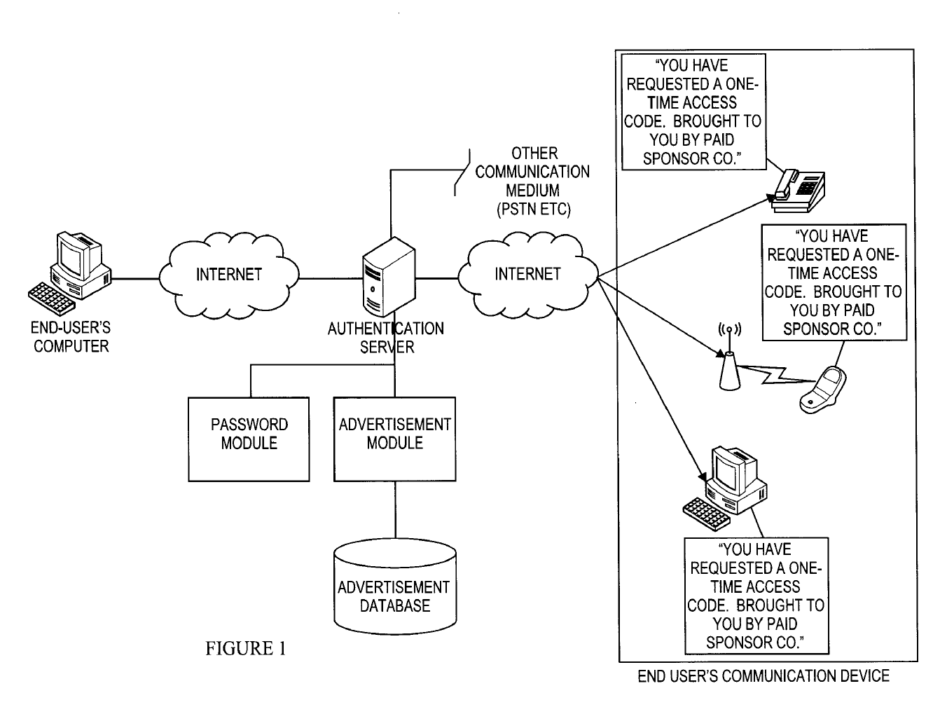

FIG. 1 illustrates a sponsored authentication system provided in accordance with the invention. An end user may conduct an Internet transaction with an online retailer, a financial institution or any other party that may require user authentication at some point. During the course of the transaction, the user may be called upon to enter a user or login identification (ID) code specific to an account number or the user. In addition, the user may be required to enter a password for authentication at the login stage or any other stage during the online transaction that may warrant additional or stronger security measures. For example, when users change passwords, make online trades of securities, or authorize the transfer of cash funds, the users may be prompted to enter a password. In some instances, a one-time password is delivered to the user. For example, the user may not remember a previous password or, by the nature of the transaction, a third party may require further authentication from the user, which calls for a one-time password to be generated and delivered. In accordance with this aspect of the invention, an authentication server may call upon a password module to establish a one-time password for the user. A variety of password generating programs and systems known to those of ordinary skill may be selected.

Furthermore, the authentication server may call upon an advertisement module to select a sponsored message to be delivered to the user. Examples of sponsored messages can include, but are not limited to: commercials, promotions, referrals, public service announcement (PSAs), weather alerts, news alerts, instructional recordings, etc. In one embodiment of the invention, the advertisement module can access a database having a plurality of sponsored messages and select one or more sponsored messages. Accordingly, the one-time password can be delivered along with a sponsored message out-of-band over another communication channel to the user. The advertisement module may also generate or select sponsored messages according to a predetermined schedule or targeted at the user based on known criteria, information gathered about the user concerning the user, or any number of factors. In one embodiment, the sponsored messages may be selected in a manner similar to a circular queue, where each sponsored message is selected in turn. In another embodiment, the sponsored messages may be selected based on rank, where the rank of each sponsored message may be determined, for example, based on the amount of consideration provided by the advertiser. In at least one embodiment, the advertisement module may be adapted to maintain a log of sponsored messages previously provided to the user in a database. Using this log, the advertisement module can prevent the same sponsored message from being provided to the user during the same or subsequent transaction. In addition, the advertisement module can use the log to more accurately determine effective targeted advertising based on the previous sponsored messages provided. It will be appreciated by those skilled in the art that the invention is not limited to an advertisement module as described herein and that there are other means to store, select, and deliver sponsored messages.

Another embodiment of the invention provides an authentication/advertising system (AAS) that can offer additional or stronger authentication by delivering additional data elements or access code via a channel different from a channel selected for a primary transaction. The AAS may contact a user who may wish to conduct a transaction via a communication channel, which may be an out-of-band channel or different from the communication channel chosen for the primary transaction. For example, a user may login to a web site via the Internet, and the system may contact the user over a short message service (SMS) communication to provide a sponsored access code on the user's mobile telephone. The user may thus enter the sponsored access code received across the second channel (e.g., a mobile phone) using the first channel (e.g., the Internet) in order to complete authentication. In other embodiments of the invention, a variety of second channels may be selected or predetermined including but not limited to pagers, landlines, e-mail accounts or other communication mediums accessible by the user to complete authentication. However, a SMS channel can be often selected which is a convenient service available on most digital mobile phones (and other mobile devices, e.g. a Pocket PC, or occasionally even desktop computers). SMS permits the sending of passwords or access codes along with short messages (also known as text messages, or more colloquially SMSs) to mobile phones, other handheld devices and landline telephones. Text messages are often used to interact with automated systems, such as ordering products online and services for mobile phones, or participating in contests.

Another embodiment of the invention further provides a system that may be used by financial institutions (FIs), or non-financial institutions to address credentials theft or suspected theft of confidential information of their users and members. The invention may be relevant to anyone that operates a service requiring remote customer access using some form of credentials and that may be subjected to fraud. An FI that may implement the invention is not required to distribute any hardware ahead of time, nor may it be required to educate its users. Preferably, device information corresponding to a user is obtained ahead of time so delivery of a sponsored out-of-band access code can be accomplished. Moreover, delivery of sponsored authentication information can be sent by the FI across different communication channels on demand rather than just relying on one medium. For example, the FI may unilaterally determine the communication channel over which an access code is to be delivered. In some instances, the access code may be sent by placing a near contemporaneous call to a home telephone number corresponding to the user conducting a financial transaction. An automated recording or interactive voice system may provide the access code pre-empted by a sponsored message or preselected piece of advertising. In other instances, the FI may elect to deploy access code and advertising information to a cell phone number, which can be done at the request of the user who may be outside the home or otherwise unable to receive authentication information at a corresponding home telephone number.

It will be appreciated by those skilled in the art that the invention is not be limited to use by FIs, but rather is applicable to any service provider that may require some level of user authentication in order to gain access to information and services, or to accomplish a transaction. Moreover, in some embodiments of the invention, reference may be made to a telephone and a telephone number, as the second factor for the authentication. While a telephone line and number may correspond to the requirements defined herein for the second communication channel, it should be appreciated by persons skilled in the art that other communication channels may be used as well, and the telephone may be used in order to provide a simple illustration of a certain embodiments of this invention.

In an alternative embodiment of the invention, the system may ensure that for each of an out-of-band or secondary communication channel, only one or a certain number of users or accounts can be authenticated. For example, security may be achieved by limiting the number of different user service accounts that may use the same authentication channel. In a household with multiple individuals, there may be a single landline dedicated for the household. As a result, an online retailer or FI may permit authentication of more than one person by sending a sponsored password over the common landline. Moreover, if the online service is related to a bank account, such limitation may be achieved by limiting the number of bank accounts that may be linked to a certain telephone number, or by limiting the number of users who may link their accounts to that telephone number, based on for example name, SSN, or whether they are members of the same family or household. It may be both expensive and logistically difficult to obtain access to a significant number of landline telephone numbers.

In the authentication system shown in FIG. 1, an end user may use a terminal, such as a personal computer, automated teller machine, PDA, telephone, cellular device, or other computing device, to conduct a transaction (e.g., login to a service, make a purchase, open a financial account, etc.) with an institution. The institution may be, for example, a provider that may provide services containing confidential or private information, including FIs, government agencies, health institutions, communication service providers or any other institutions, authorities or entities. The end user and the institution may communicate, for example, via one or more communications network(s) such as the Internet, a cellular system, intranets, data lines, a combination of networks, etc. In an embodiment of the invention, the institution may provide a web page on a site which is displayed on a user computer system. The institution may include a hosted system and an online system which may include an authentication server and module. In some embodiments of the present invention, the hosted system and online system, in whole or in part, may reside within the institution while in other embodiments of the invention they may reside outside and be managed by a third party service provider.

An authentication module may be a self-contained software module or integrated with an online system. For example, the authentication module may be a plug-in which may communicate via a communications network or other methods with an authentication server. Authentication, including sponsored out-of-band authentication described herein, may be accomplished at one institution or FI. The communication network may be a combination of hard wired links, wireless links and/or any other communication channels. In accordance with this aspect of the invention, the user may conduct a transaction such as opening a banking account, purchasing goods or other transactions. The user may login to a dedicated web site via the Internet or other communication medium and supply the user a sponsored password. For example, a banking online system or institution server may contact the user via a different out-of-band channel, such as via a mobile phone or a landline telephone. The user communication device may receive a sponsored secret message, data element or code word via the additional channel. The user may thereafter enter the secret message via the first channel after receiving and hearing the sponsored message accompanying the secret message in order to login to the system and/or conduct a transaction.

As referred to in this description of the invention the term “transaction” or “transactions” may refer to any of the following non-limiting examples of online or other transactions, interactions, enrollment to a service, re-enrollment and password recovery using some sort of authentication/challenge or use of various services. It should be noted that the term transaction is applicable not only to financial transactions but to any transaction involving authentication including non-financial transactions such as the display or viewing of e-mail content or attachments to protect privacy interests or private information. For example, without limitation, transaction refers not only to transactions such as an online banking login, but also to a company extranet login. It should be applicable to any transaction where the user is being authenticated by some means, regardless of the purpose of the authentication. Without limiting the foregoing, the following list illustrates certain types of transactions it may apply to: (1) online enrollment, such as financial account opening; banking, brokerage, and insurance; subscriptions for example for ISP, data and informational content deliveries; customer service enrollment; enrollment to programs and any other similar type of transaction; (2) online transactions such as online purchasing, B2B (buyer to buyer), B2C (buyer to consumer) and C2C (consumer to consumer) transactions; electronic bill payment; Internet ACH providers; money transfers between accounts; online brokerage trading; online insurance payments; online banking transactions; tax filing or any other similar type of transaction; (3) online applications such as for credit cards, loans, memberships, governmental applications or other similar type of transactions; (4) online password resetting, as well as online changes or updates to personal data by re-authentication/re-enrollment, by combining a mechanism involving secret questions, or by a combination of any of the above; (5) any login to a restricted service, or other operations that involves an element of risk of fraud.

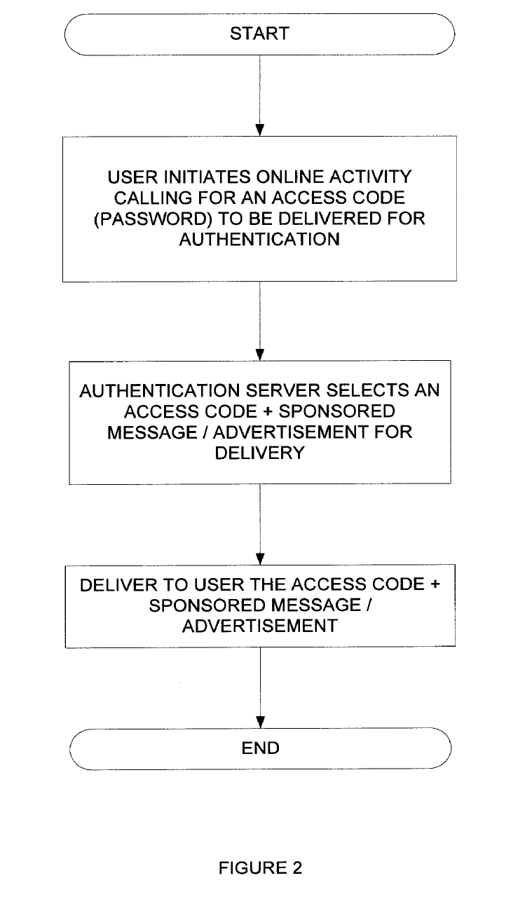

FIG. 2 is a flowchart depicting a process according to a preferable embodiment of the invention. A user may initially access an institution in order to receive service over an initial communication channel such as the Internet. For example, the user can make a request to open an account, pay a bill, transfer funds, or purchase goods or request services from an institution. The user may thus initiate online activity calling for an access code or password that can be or needs to be delivered out-of-band to the user for authentication. The user or customer may receive the access code or password via an additional communication channel, for example, a mobile device number, a landline telephone or any other communication channel as described elsewhere herein. An authentication module or application may contact other modules or units of the system in order to obtain and check that the information supplied by the user for the additional channel may be used, for example, if the telephone number supplied is not associated with a number of accounts or other elements of the system. An authentication server may subsequently select an access code or password and a sponsored message to deliver to the user. The sponsored message may be selected from a database based on a fixed schedule or selectively targeted for the user as described in other embodiments of the invention herein. The information to be collectively delivered to the user may be transmitted over an out-of-band communication channel selected by the institution and/or the user. The information may vary according to the communication channel selected or type of selected user device that is to receive the access code or password. For example, a different advertisement message may be displayed or played to the user if it is transmitted to a cell phone, landline or an e-mail account. In an alternate embodiment of the invention, the same message may be displayed or played to the user across all receiving devices corresponding to the user (“You have requested a one-time access code. Brought to you by Paid Sponsor Co.”). Rather than receiving a completely automated message, the user may also speak with a live person or operator to discuss the transaction following presentation of the advertisement. In addition, the user may be asked to provide some type of verifying information delivered over the initial communication channel before the complete or partial password information is relayed to the user over the out-of-band communication channel. Accordingly, an advertisement or sponsored message can be delivered along with the password information to the user which can be entered on the web site for the institution to complete the selected online activity.

Although the scope of the invention is not limited in this respect, embodiments of the invention may be used for password recovery. An embodiment of the invention provides methods and systems for delivering a sponsored message when delivering password recovery information. For example, the following procedure could be implemented when a user fails to remember a password for an online account:

1. After a successful initial authentication, a user may be identified according to a user-device mapping, which may use the IP address and/or cookie, or a user-phone mapping.

2. When a user logs into an online account from a familiar device, and may forget the password, the system may send a one-time password via an out-of-band channel such as a telephone number registered to the user.

3. The user may receive a sponsored one-time password over an out-of-band channel that is entered to gain access to the online account, and may subsequently create a new password.

User profiles may be modified through an online account. An updated contact profile or telephone list corresponding to the user may be updated after logging into a system account. In addition, the system may occasionally initiate such updates by sending reminders to the users. Updates may be allowed only from familiar devices in certain instances.

Out-of-band authentication is a convenient way to leverage communication channels that already exist and are easily accessible to customers. These include voice-calls to a telephone, SMS to a mobile phone, or e-mail to a computer and/or mobile device. All these mediums allow the user to confirm a particular transaction using alternative channel already registered with an organization.

The systems and methods of authentication provided in accordance with the invention can also be varied by allowing the selection of a particular out-of-band channel to be used based upon a user, user group, transaction or other criteria based upon the relative desired security of a particular out-of-band channel.

For example, the selection of an out-of-band channel could be made from among many channels and user devices such as mobile telephones, mobile e-mail devices, personal digital assistants, mobile pagers, and other wireless transmission channels. Other alternatives include home telephone numbers, business telephone numbers and other land based communications channels. Additionally, the security of these various mobile and land based communications channels could also be increased or decreased based on the use of digital encryption and signature techniques and other analog security mechanisms. For example, with respect to users, user groups, transactions or other activities requiring relatively lower security, it may be appropriate to communicate an out-of-band password over a channel through a device where messages may be more easily intercepted or where the device may be more easily lost, such as is the case for mobile telephones or mobile e-mail devices. Alternatively, with respect to users, user groups, transactions or other activities requiring relatively higher security or stronger authentication, it may be appropriate to communicate an out-of-band password over a channel or through a device where messages are more difficult to intercept or where the device is more secure, such as is the case for communications channels that use security features such as encryption or digital signatures or telephones that are less likely to be misplaced or lost, such as home or business telephones. Given that stronger authentication measures often involve greater cost, complexity and overhead, the invention herein can selectively provide sponsored out-of-band passwords across different communication channels to various user devices.

In an alternative embodiment of the invention, a graphical user interface (GUI) can be included in the out-of-band communication which also contains data representing the generation of one-time passwords or confirmation numbers that are transmitted along with a transaction summary to the user. This can be done directly via e-mail or SMS, or sent through voice to a registered phone number. Once the password or confirmation number has been received via the different channel, it is simply entered by the user and the transaction is approved over the initial channel or medium.

Furthermore, the authentication security level can also be improved by an authentication unit or module that splits an access code or password across one or more out-of-band channels. Instead of sending a user an entire password only to an e-mail address, the authentication unit can create multiple different passwords or split a password into various portions which are sent as different portions (or passwords) across multiple out-of-band channels such as an e-mail address channel and phone SMS message channel. The user can then enters the passwords received from the two or more different channels as the single authentication password that is then received by the authentication unit via an in-band channel. In another embodiment of the invention, a user can be prompted to enter a username and a first half or portion of a password during an online transaction taking place over a first communication channel such as the Internet. An authentication/advertising system configured in accordance with the invention can receive this information, and upon verifying it, sends back the remaining half or portion of the password to the user by automatically generating a message to a beeper designated by the user, preferably ahead of time, across a second communication channel. The beeper display may indicate the remaining password portion, which is then entered by the user to complete a logon process or other online activity taking place over the first communication channel. Accordingly, the identity of the user can be thereby authenticated with a reasonable level of confidence or assurance that a hacker or fraudster does not possess the means to receive the out-of-band response (i.e., the beeper).

For any of the examples described herein, an authentication server or any other suitable authentication module or unit may have a suitable computer processor that executes stored executable instructions stored in memory. When executed, the instructions or computer program can instruct the processor to carry out the desired operations as described herein. Accordingly, a variety of hybrid advertising/authentication schemes are provided which depend upon the level of authentication and advertising that is desired. It is therefore possible to provide more targeted advertising and/or stronger or variable authentication interactions between a user and an authentication unit or server.

As discussed above, authentication policies may be determined for users, user groups and/or transactions based on an operator selecting the authentication strength level. Furthermore, multiple questions can also be asked as part of an authentication process and/or passwords can be split and sent via multiple out-of-band channels. Such policies can be enforced in response to a successful first level of authentication (e.g., username and password or password and PIN) or one or more successful previous second level of authentication challenges. For example, in the instance of a knowledge based system, the plurality of questions and corresponding answers as previously provided by the user, may be stored in a suitable database, as known in the art, and submitted as part of a further authentication challenge which includes a differing number of questions and/or differing level of difficulty of questions to provide an authentication challenge as part of a current session or to carry out a certain transaction such as a financial transaction via an online transaction where differing screens that are presented to the user may provide differing authentication strength levels by varying the number of questions presented to the user or the level of difficulty of the questions varies as a user attempts to access different services, applications or other desired resource. It shall be understood that selective advertising may be delivered as part of any such authentication policies in accordance with the invention.

While most alternative out-of-band channels described herein rely upon some form of electronic signal transmission, any of the concepts of the invention herein may be applied to non-electronic communication channels such as paper based or courier based delivery solutions. For example, it may be preferable to send access codes or passwords using the U.S. mail system, approved couriers or a traditional overnight service, such as Federal Express, which deliver the access codes or passwords in physical form. Alternatively, out-of-band channels herein further include paper (or desktop/electronic) facsimile machine transmissions that deliver entire or partial passwords and/or PINs electronically over a wired or wireless network. As with other embodiments of the invention described elsewhere herein, catalogs and other paper based advertisements can be delivered along with accompanying access codes or passwords.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method of delivering a sponsored message to a user during an authenticating transaction comprising the following steps of:
selecting an authentication server coupled to a computer readable memory with password information and a selection of sponsored messages;
requesting an out-of-band password from the authentication server during the authenticating transaction via a first communication channel; and
delivering the out-of-band password to the user accompanied by a sponsored message selected from the selection of sponsored messages via a second communication channel.

2. The method of claim 1, wherein the first communication channel is user defined or selected.

3. The method of claim 1, wherein the second communication channel is a telephone connection.

4. The method of claim 1, wherein the second communication channel is at least one of the following: an e-mail connection, a US mail service, an overnight or personal courier service, a facsimile machine transmission.

5. The method of claim 1, wherein the authenticating transaction is for a financial or non-financial transaction.

6. The method of claim 1, wherein the first communication channel is the Internet and the second communication channel is a telephone connection.

7. The method of claim 6, wherein the authentication transaction is for a financial or non-financial transaction performed over the Internet.

8. A computer-readable medium for delivering a sponsored message to a user during an authenticating transaction including instructions that when executed on a computer cause the computer to:
select an authentication server coupled to a computer readable memory with password information and a selection of sponsored messages;
request an out-of-band password from the authentication server during the authenticating transaction via a first communication channel; and
deliver the out-of-band password to the user accompanied by a sponsored message selected from the selection of sponsored messages via a second communication channel.

9. The computer readable medium of claim 8, wherein the first communication channel is user defined or selected.

10. The computer readable medium of claim 8, wherein the second communication channel is a telephone connection.

11. The computer readable medium of claim 8, wherein the second communication channel is at least one of the following: an e-mail connection, a US mail service, an overnight or personal courier service, a facsimile machine transmission.

12. The computer readable medium of claim 8, wherein the authenticating transaction is for a financial or non-financial transaction.

13. The computer readable medium of claim 8, wherein the first communication channel is the Internet and the second communication channel is a telephone connection.

14. The computer readable medium of claim 13, wherein the authentication transaction is for a financial or non-financial transaction performed over the Internet.

15. A system for authenticating a transaction with a user, the system comprising:
an authentication server configured to receive a request from a user over a first communication channel for an out-of-band password; and
a password generating module to generate the out-of-band password; and
a targeted advertising module to select an advertisement; and
wherein the authentication server transmits the out-of-band password to the user over a second communication channel accompanied by the advertisement derived from the targeted advertising module.

16. The system of claim 15, wherein the first communication channel is user defined or selected.

17. The system of claim 15, wherein the second communication channel is a telephone connection.

18. The system of claim 15, wherein the second communication channel is at least one of the following: an e-mail connection, a US mail service, an overnight or personal courier service, a facsimile machine transmission.

19. The system of claim 15, wherein the authenticating transaction is for a financial or non-financial transaction.

20. The system of claim 15, wherein the first communication channel is the Internet and the second communication channel is a telephone connection.

21. The system of claim 20, wherein the authentication transaction is for a financial or non-financial transaction performed over the Internet.
